(19) United States
(12) Patent Application Publication
(10) Pub. No.: US 2006/0165465 A1
(43) Pub. Date: Jul. 27, 2006

(54) Two module splash resistant keyboard

(76) Inventor: Lee Hong Wu, Lake Forest, CA (US)

Correspondence Address: LAW OFFICES OF J.F. LEE, 17800 CASTLETON STREET, SUITE 383, CITY OF INDUSTRY, CA, 91748, US

(21) Appl. No.: 11/387,199

(22) Filed: Mar. 22, 2006

Related U.S. Application Data
(63) Continuation-in-part of application No. 10/439,938, filed on May 16, 2003, now abandoned.

(51) Int. Cl. B41J 5/12

(52) U.S. Cl. 400/491

(57) ABSTRACT

A two module keyboard with splash-resistant mechanism has a key module that can be separated by a user from a base module. One group of components becomes a detachable and user-serviceable key module, while the other group stays as the base module. The detachable module contains essentially the keycap portion that causes substantially more malfunctioning of present day keyboard components than the rest. The base module has a bay that receives the detachable key module, and contains the electrical circuitry membrane and PCB that has longer durability than the key portion. Drain holes at lower end of the bay will allow liquid spillage, or water/solution if used to clean the bay, to flow out of the keyboard. Depending on applications, the detachable key module can be further broken into more sub-modules. Keyboards made according to the present invention are modular in nature, and are conducive to reducing the costs for keyboard related services and exchanges, costs for curing accumulative environmental hazards and costs for fitting suitable user keys for swapping among different languages and computer applications.

### CROSS REFERENCE TO RELATED APPLICATION

This is a continuation in part of application Ser. No. 10/439,938, filed May 16, 2003, entitled A New Type of Splash-Resistant Modular Keyboard for Computers. The present application is related to a prior application filed by the same inventor. Said prior application's filing date was Jun. 26, 2002, having application Ser. No. 10/180,423. The present application is further related to a second application filed by the same inventor. Said second application's filing date was Oct. 15, 2002, having application Ser. No. 10/272,584.

### BACKGROUND OF THE INVENTION

A. Field of the Invention

The present invention relates generally to keyboards for computers where a top mechanical section containing the keycaps or keys is replaceable, removable and user-serviceable away from a bottom electronics section. More particularly, the present invention helps to solve the industry problems enumerated, but not limited by, below:
A. Voluminous amount of keyboards still under warranty are being returned for repair/exchange due to malfunctions that are user-serviceable in nature. The amount of money that will be saved by avoiding such repair/exchange is estimated at least in the millions of dollars every year across the industry.
B. Currently, a substantial amount of metal and rare metal contained in the electronics section of a keyboard turns into scrap metal causing environmental hazards some years down the road notwithstanding the electronics section has a higher durability than the mechanical key-stroke section, which has not been made user-serviceable by itself. People are waking up to the potential hazards created by castaway computers, cell phones and other consumer electronics. The instant invention may save tremendous amount of money with reduced costs to cure the potential environmental hazards.
C. Chances of breakdown on the otherwise non-removable part of the keyboard is greatly reduced according to the present invention due to the fact the liquid spillage will no longer accumulate in the holding (aka bay) area.

B. Discussion of Related Art

Modern day keyboards for computers come in an integrated package, along with the computer system units when sold. Users can plug in the keyboard cord to a port at the back of the system unit and can then start to type on the keyboard when the desktop computer is working.

Latest generations of computers are more compact than ever before. The whole system (CPU, memory, I/O ports, DVD/HD/Floppy drives and other optional equipment or connection ports) can arguably be in a single package the size of a traditional keyboard, so that a user merely sees and uses the “keyboard” to work on the computer. An example can be found at www.cybernetman.com located in Irvine, Calif. In this type of new generation computer, keyboard becomes integrated and on top of the system, similar to the notebook/laptop computers today.

Most keyboards carry limited product warranty, on the condition that users do not take apart, disassemble or remove parts of keyboard in any way. Any such action voids the product warranty. If the keyboard develops any malfunction, the only recourse under the warranty is to have it returned for repair or exchange. Some manufacturers have sticker(s) covering one or more screws used to fasten the keyboard parts together. Any breaking or removal of such sticker(s) will also void the warranty.

In today's technology, most keyboards have fairly high quality and durability. However, in the real-life working environment, keyboards are destined to encounter some foreign objects that tend to cause problems, including, just to name a few, grease from fingers, liquid spillage, dusts and particles in the atmosphere. Without any means to clear the accumulated foreign matter away, inevitably the mechanical functionality of the keyboard is adversely affected.

Typical symptoms include, keys stuck in the holding chimneys by the accumulation of dried coffee, grease or dusts. Due to the “void the warranty” restriction, the only solution is to return the keyboard for repair service or in exchange for a new one. Since the keyboard industry in general does not factor in the cost of recycling keyboard components, the cost of sending out a new keyboard to users is lower than the labor cost of diagnosing, fixing and re-assembling a returned keyboard. Hundreds of thousands of returned keyboards gravitated towards storage bins, warehouses and even garbage dumps each year, while no one bothers to figure out how to make the best use of the re-useable resources and come up with a more environmentally sound solution to the problem.

Working environment of computers is also changing. New generation of automobile on-board computing are fast replacing car electronics with fully functional computer stations for safer driving or office work as well as entertainment where wireless keyboards still play the primary role as an input interface, which becomes more susceptible to vibrations and liquid spillages.

In the case of notebook/laptop computers, or in the case of the new generation compact computers, when a problem occurs that relates to the keyboard, the only recourse a user has is to send back the whole system unit for repair or exchange.

The present invention examines the structure of a typical keyboard for modern day computers, and proposes a new modular keyboard structure that helps to solve the industry problems.

Modern day keyboards for desktop computers are usually produced by using an upper and a lower enclosures (the outer shells for the finished keyboard product) for all internal components, which typically include key component, key-actuating mechanism, top holding plate, circuitry membrane and PCB, bottom holding plates/frame, and other optional components. Reference FIG. 1 and FIG. 2.

Since each manufacturer may have different assembly method, or may combine one part into another (bigger) part, understandably the components in FIGS. 1 and 2 are just typical and not exhaustively representative.

From top to bottom (in the usual orientation of daily usage), these typical internal components (excluding the top/bottom enclosures) are listed and explained below:
1. a key component: includes the following typical sub-components
   a. individual keys 1 with alphanumeric characters and other control keys for any specific language. The surface of each key, printed or labeled with character(s) for visual identification, is for human fingers to type on.
   b. a key-holding mechanism to provide for the vertical up-down travel of each key 1 when pressed down and then popped back. The mechanism can be in the form of a chimney 2, as in FIG. 2, or in the form of a scissor switch 3, as in FIG. 1.
   c. a frame 4 for the holding mechanism 3 to sit on. In today's manufacturing process, the frame and the holding mechanism is usually an integrated structural piece.
2. a top holding plate 5: optional, serves to hold down the key actuating mechanism 6 and protect the components beneath.
3. a key-actuating mechanism 6: provides resistance and position restoration for the up-down travel of each key 1. There are some variations as to the type of mechanism used for keyboard, to name a few:
   a. rubber domes 7 in one-piece sheet: most common today, which uses dome-shaped material corresponding to each key 1.
   b. coil springs: vertical placement of coil springs along the up-down travel of each key, common for earlier generation keyboards; classical way of providing resistance and position restoration for each key.
   c. a flexible metal plate.
   d. buttons formed by sealed air bubbles on rubber or plastic material.
4. a circuitry membrane and PCB 8: the combined circuitry membrane and PCB (printed circuitry board) electronically determine which of the keys is being pressed down and send that information to the computer for further processing.
5. a bottom holding plate 9: used to hold the aforesaid components in place.

It is well known in the industry that these components are just typical, because a lot of variations exist due to different designs and manufacturing processes. For example, in earlier keyboard models, the coil springs for key-actuating mechanism are integrated with and became part of the key component.

FIGS. 1 and 2 sum up the structural allocation of a typical keyboard for computers. As most people can experience, these typical keyboards cannot be separated into two or more modules that can be physically removed, detached, replaced, swapped or serviced.

U.S. patent application publication US 2003/0223797 A1 describes the use of ‘rubber sheet’ to use as a ‘water barrier’ for the water resistance feature. The 797 application describes a modular keyboard assembly 120, which is meant to be a subassembly of a whole keyboard assembly 100 but not encouraged to be disassembled by a user for maintenance. Distinctive feature of the above 797 application is that in the housing 103 a liquid resistant barrier 130 is secured between the keys 102 and the circuit board 140. It lacks any solution for the user to casually detach liquid-contaminated areas from the whole keyboard assembly for cleaning.

U.S. Pat. No. 5,996,284 to Youn describes a ‘keyboard mounting apparatus’ to hold the entire keyboard assembly to the notebook computer.

U.S. Pat. No. 5,612,692 to Dugas describes a method of keyboard assembly in the traditional design. The entire keyboard assembly from top to bottom is assembled together to form and seal the liquid from getting into the keyboard. U.S. Pat. No. 5,150,118 to Finkle describes the assembly of the ‘custom panel having interchangeable key-pad assembly that are installed on a keyboard’. The aperture 64 is employed to ‘captivate the keys’ with the sub-panel 32.

However, the above two patents do not attempt to separate circuit board from the keys portion to eliminate any concern for a computer user to be exposed to the electronic circuit board of the keyboard when the user himself or herself needs to service the keys portion.

U.S. Pat. No. 5,865,546 describes a method of liquid draining out of the key assembly to the bottom of the keyboard, the out of the notebook computer. Similarly, U.S. Pat. No. 6,641,317 describes the assembly of draining hole to the bottom of the keyboard assembly.

One object of present invention seeks to greatly reduce the costs of diagnosing, fixing and reassembling a returned keyboard, or exchange for a new one, when warranty still applies.

A further object of present invention is to create a keyboard manufacturing technology that is environmentally friendly and is conducive to elimination of future environmental hazards.

A still further object of present invention is to reduce the liquid spillage that stays in the keyboard holding area, thus creating moisture, which tends to adversely affect other system components of the computer.

A still further object of present invention is to allow easy maintenance and cleaning of the keyboard with clean water sprays or other solution at the keyboard since the keyboard holding area (aka bay) has drainage to channel out the water or solution containing dust or other particles.

### SUMMARY OF THE INVENTION

A modular computer keyboard of the present invention separates keyboard components into two groups to incorporate a splash-resistant mechanism.

The present invention provides a two module keyboard with splash-resistant mechanism comprising: a key module generally shaped into a board having at least four sides and including a plurality of keycaps, a key holding mechanism and a frame, the key-module containing no electronic circuitry and being self-sustainable in and out of the keyboard; a base module containing the electronic circuitry used for decoding the signals of the keycaps depressed by a computer user to provide the decoded signal to the computer through a wired or wireless connection, wherein the base module defining a bay area across most of its upper surface shaped to fit the key module when it docks into the bay in manufacturing process and subsequent events of maintenance performed by the user; the bay of said base module being tilted from the horizontal plain to an adjustable degree and having an inner rim abutting the key module at its entire sides leaving a plurality of holes for communicating the inner space of the rim to lowermost points of the tilted bay; a water-sealing mechanism disposed around the inside lower rim of the bay, so that any liquid spillage or splash into the space between the key module and base module will not get inside the body of the keyboard or notebook/laptop computer but gravitates towards said holes and out of the computer; and a means for releasably mounting the key module onto the base module or the bay, whereby the user may seat and unseat the key module in and out of the base module casually for cleaning behind the key module to remove liquid or foreign matter normally untouchable by the user.

One group of components of the keyboard becomes a detachable and user-serviceable key module, while the other group stays as the base module. The detachable module contains essentially the key portion that should endure more than ten million strokes per key with occasional liquid spills and thus malfunctioning tends to occur more as in the present day keyboards. The base module has a bay that receives the detachable key module, and contains an electrical circuitry membrane and PCB that contains no moving parts and has longer durability than the key portion. Drain holes at the lower end of the bay will allow any liquid spillage, or when using water/solution to clean the bay, to flow out of the bay. Depending on applications, the detachable key module can be further broken into more sub-modules. Keyboards manufactured following present invention are modular in nature, and are conducive to reducing the costs for keyboard services and exchanges, costs for curing future environmental hazards and costs for fitting suitable user keys for swapping among different languages and computer applications.

### BRIEF DESCRIPTION OF THE DRAWINGS

The accompanying drawings, which are incorporated in and constitute a part of this specification, illustrate the preferred embodiment of the invention and together with the description, serve to explain the principles of the invention.

For reason of definition, and for further explanation of present invention, the term “key module” will be used to denote the module that contains, minimally, the keys, key holding mechanism and frame for key holding mechanism.

The term “base module” will denote the module that contains, minimally, the circuitry membrane and PCB and is interchangeably used with “key bay” which is defined by the base module to seat the key module. As a matter of practice, in a keyboard produced following the teachings of present invention, anything on the keyboard other than the “key-module” is the “base module”. Therefore, base module can be the system unit of a notebook/laptop computer, or, in the case of new generation computer, the system unit of a desktop computer, excluding the display monitor.

Depending on specific manufacturing technique, the present invention allows the component of a key actuating mechanism to be allocated into the key module or the base module.

The cavity left in the base module when key module is removed is referred to as key bay.

Drain holes on the key bay are also referred to as water channeling mechanism.

A brief description of the drawings is as follows:

FIG. 1 shows the typical components of a prior art keyboard for notebook/laptop computers.

FIG. 2 shows the typical components of a prior art keyboard for desktop computers.

FIG. 3 shows the exploded view of the inventive keyboard where the key module is removed from the base module, with water channeling mechanisms (holes) and water sealing mechanism indicated. A method for mounting key module to the key bay of base module is also shown.

FIG. 4 shows the key module is removed form the base module, in this case, the system unit of a notebook/laptop computer. Water sealing mechanism around the inside edge of key bay is also shown.

FIG. 5 shows the key module can be broken into sub-modules; or can be in the form of a foldable type.

FIG. 6 shows an implementation of the water channeling mechanism by using drain holes and tilting the system unit of a notebook/laptop computer so that liquids will gravitate towards the drain holes and flow out of the key bay.

FIG. 7 shows an implementation of the water channeling mechanism using drain holes, with key module sitting in the key bay.

FIG. 8 shows the application of present invention to desktop computer keyboards using key sub-modules.

FIG. 9 shows a cross-section view of the components for a desktop computer keyboard applying water sealing mechanism and water channeling mechanism.

FIG. 10 shows an exploded view of the components for a notebook/laptop computer key applying water-sealing mechanism.

FIG. 11 shows that key module can be mounted and secured to the base module by screws in the top-down orientation.

FIG. 12 shows the key module can be mounted and secured to the base module by another form of snap-in mechanism. In this drawing, upper enclosure of the traditional desktop computer keyboard is part of the key module.

FIG. 13 shows the key module can be mounted and secured to the base module by employing tabs with holes extending from the sides of key module, and corresponding cavities on the sides of the base module with sliding locking pins.

FIG. 14 shows the key module can be mounted and secured to the base module by horizontally sliding the key module into the base module.

FIGS. 15 and 16 show two examples of implementation by the present invention with assembled key module sitting in the key bay, along with portions of base module forming water sealing environment.

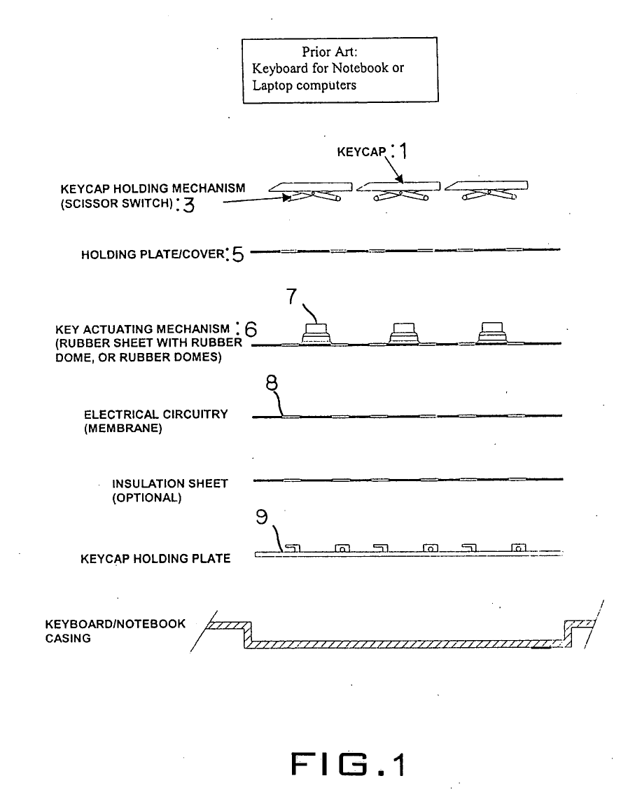

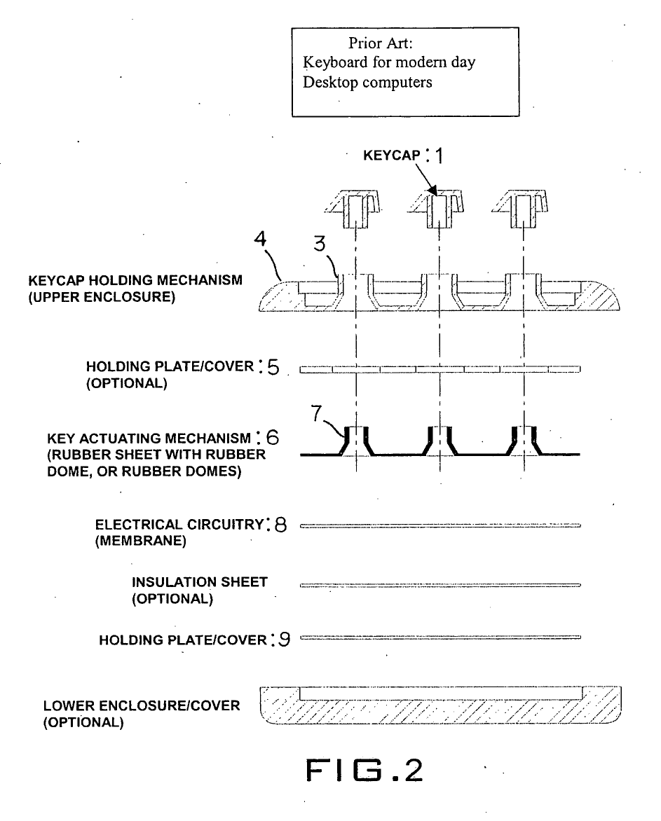

Similar reference numbers denote corresponding features throughout the attached drawings.

### DETAILED DESCRIPTION OF THE PREFERRED EMBODIMENT

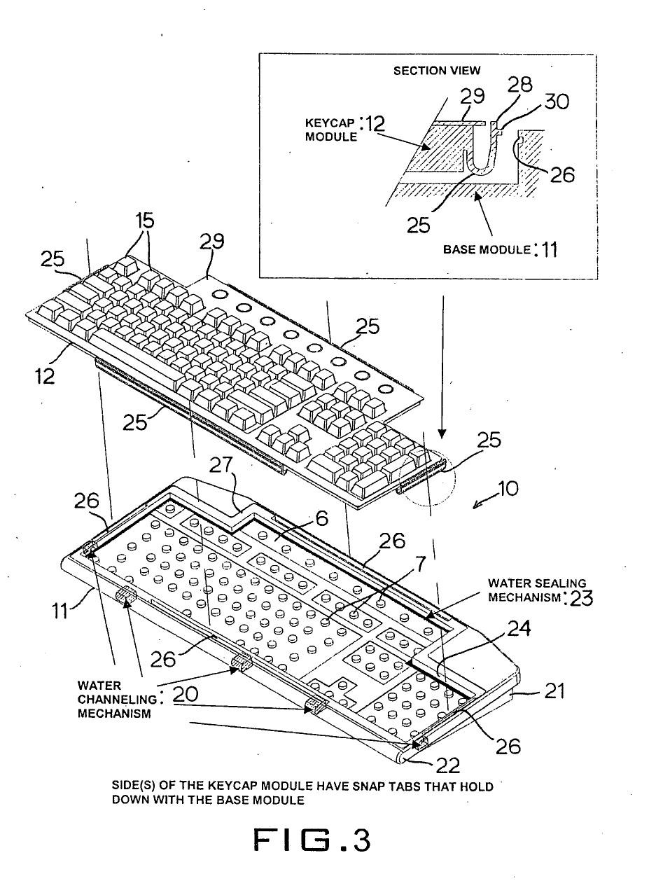

Referring to FIG. 3 and thereafter, the embodiments of the present invention will be described. Terms “key module” and “base module” as used herein are defined in prior section.

A keyboard 10 shown in FIG. 3 is a first embodiment of the present invention. The keyboard 10 is generally comprised of a rectangular base module 11 and a T-shaped key module 12. The base module 11 defines a bay area across most of its upper surface shaped to fit the key module 12 when it docks into the bay 11 in manufacturing process and subsequent events of maintenance at home or office.

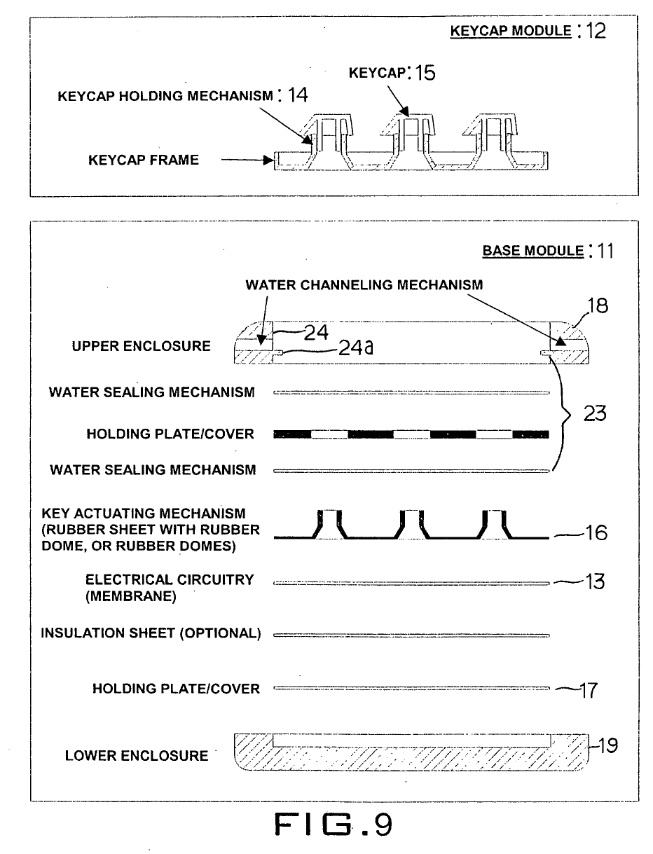

The key module 12 contains no electronic circuitry and is self-sustainable in and out of the keyboard to maintain its integrity. Meanwhile, even if the key module 12 is removed, the base module 11 houses the supporting components for the operation of the keyboard 10 in a water resistant manner. As a matter of practice, the base module 11 will at least have an electrical circuitry/PCB component 13 as shown in FIG. 9. The electronic circuitry 13 is used for decoding the signals of the keystrokes by a computer user to provide the decoded signal to the computer through a wired or wireless connection.

From top to bottom, the components of the keyboard 10 will include a top key-holding plate 14 for supporting multiple keycaps 15 in their free vertical movements within a limit provided by a retaining means not shown, a key-actuating mechanism 16 in a resilient sheet formed with upward domes for biasing the keycaps 15 at a raised level, the electrical circuitry membrane/PCB 13, a bottom holding plate 17, upper and lower enclosure halves 18 and 19, which allow the key-actuating mechanism 16 to be connected to the keycaps 15 of the key module 12 mechanically but not permanently as shown in FIGS. 9, 15 and 16.

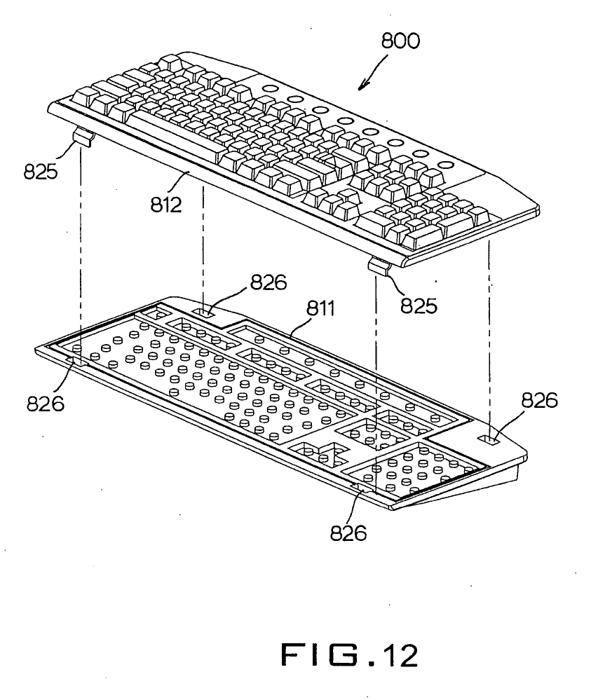

The upper enclosure 18 corresponding to the hard plastic casing of a keyboard for a traditional desktop computer may be grouped into the base module 11 as in FIG. 9 or a key module 812 as will be described with reference to FIG. 12.

The key-actuating mechanism 16 comprises a rubber dome and/or a spring integrated into each key 15 for providing a feedback. These mechanisms both provide the right feel to the user and reposition the key 15 after it has been released.

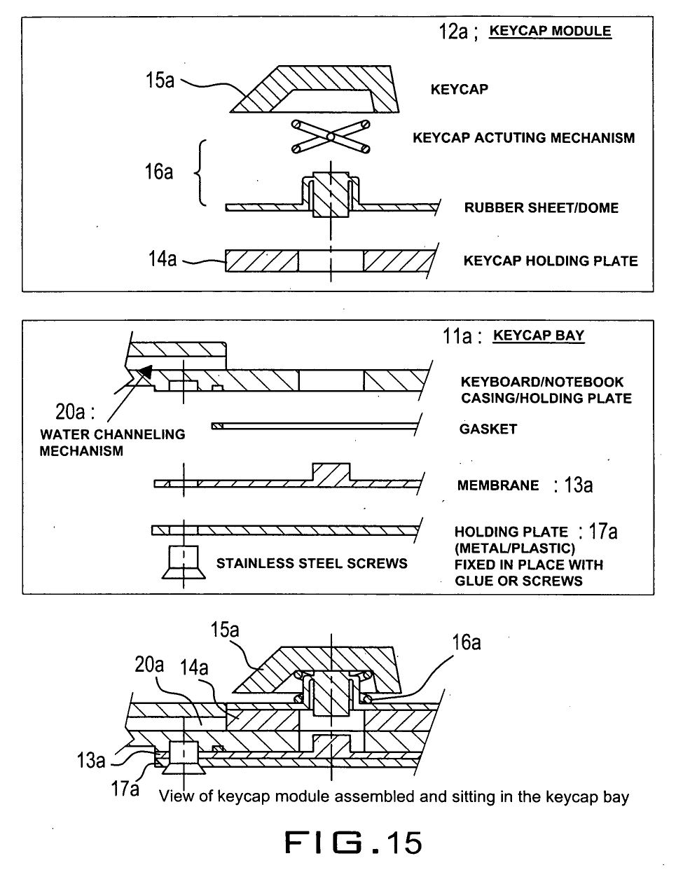

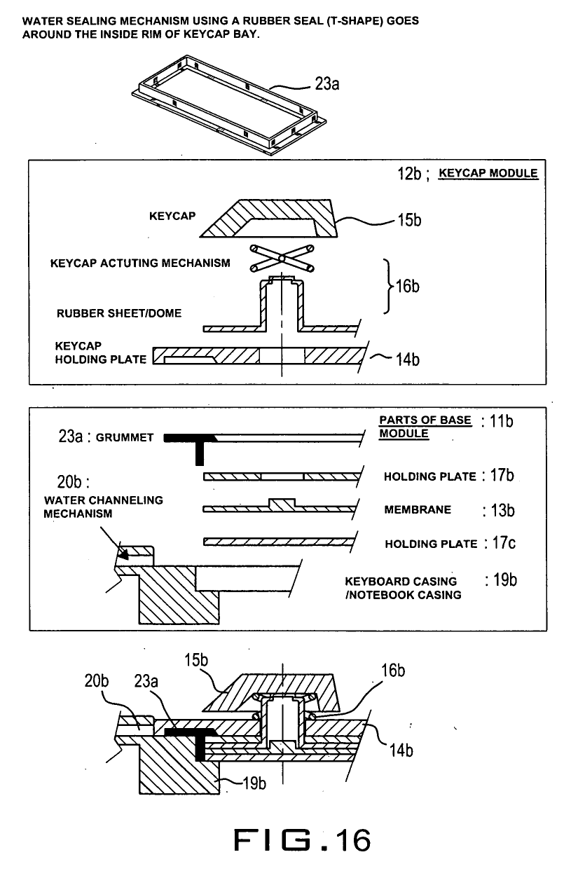

Depending on specific manufacturing or assembly needs, the key-actuating mechanism 16 may be grouped into either the base module 11 as in FIG. 9 or the key module 12 as will be described with reference to FIGS. 15 and 16.

FIG. 3 shows the keyboard 10 having various arrays of rubber domes 7 formed on a single elastomeric sheet in spaced groups of various inputs such as alphabets, numbers, and software functions, etc. Drain holes 20 serve as a water channeling mechanism at one end of the keyboard 10; the whole keyboard unit 10 is elevated on one side 21, causing the side 22 with drain holes 20 to be lower. Water-sealing mechanism 23 around the inside rim 24 of the key bay 11 is shown. Rubber strips or sheets are preferred material for achieving the water sealing, without blocking the drain holes 20 on the lower end 22 of the key bay 11.

The key module 12 has tabs 25 at its four sides, which can be snapped in to grooves 26 on the inside rim 27 of the key bay. Each tab 25 is U-shaped in cross section and ends with an outer end 28 extending perpendicularly up to the level of a top surface 29 of the key module 12. The tab end 28 of the base module 11 has at its outer sidewall a laterally extending protrusion 30 adapted to be received in a lateral groove 31 formed in the rim 27 of the base module 11. When the key module 12 is introduced into the base module 11, the four side tabs 25 are resiliently flexed away from the rim 27 of the base module 11 and immediately return to their normal positions and then snap into the grooves 26 to secure the two modules 11 and 12 to each other.

In the event of maintenance, the tabs 25 may be flexed out of the grooves 26 using a simple prying edge in order to release the key module 12 from the base module 11 for cleaning or other purposes.

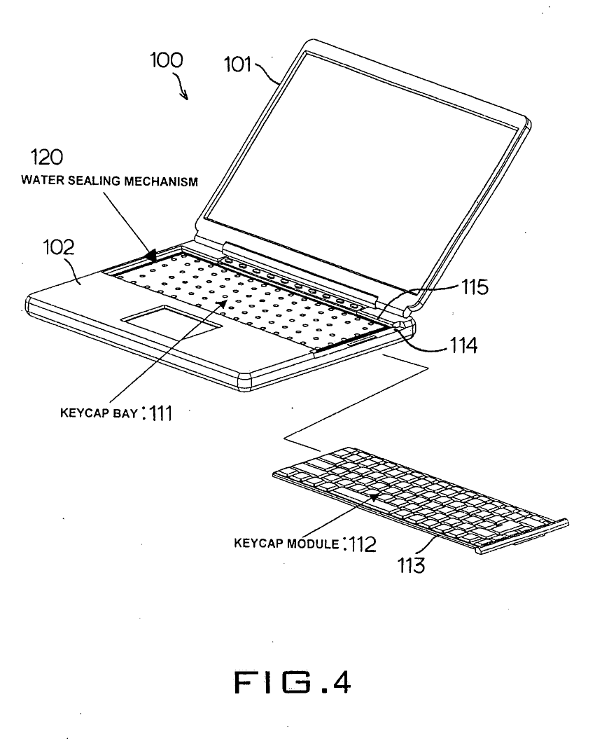

FIG. 4 shows a notebook/laptop computer 100 having a monitor 101 hinged to a system unit 102, which comprises a base module or bay 111 on the top surface. A key module 112 is shown removed from the bay 111 to expose a water sealing mechanism 120 applied to around the inside edge of the bay 111.

The key module 112 has two opposite side edges 113 for sliding engagement with opposing guide rails 114 formed in an inward rim 115 of the bay 111.

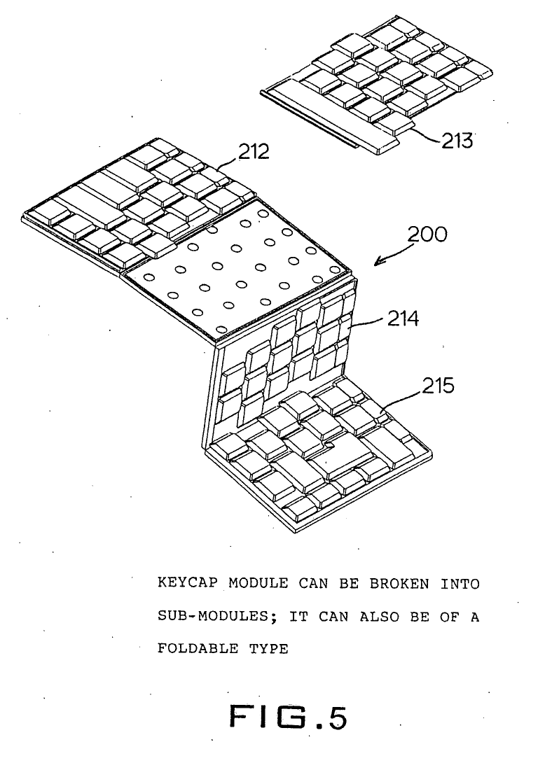

In FIG. 5, a keyboard 200 according to another embodiment of the present invention encompasses the type of key module where it can be broken into sub-modules 212-215, or it is of a foldable type.

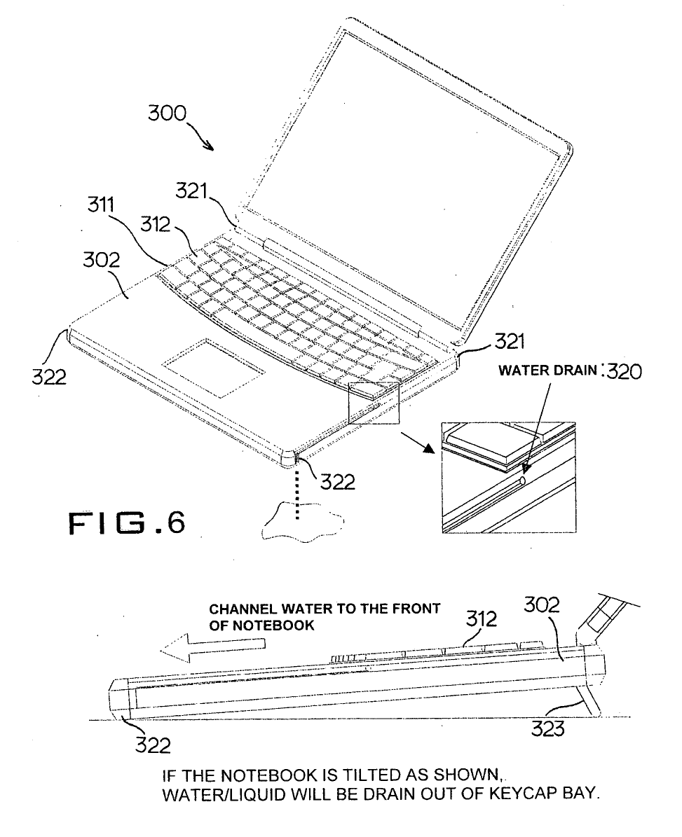

FIG. 6 shows another notebook computer 300 having a system unit 302 wherein side drain channels 320 function as the water channeling mechanism. The notebook computer 300 has a base module or bay 311 in which a key module 312 is removably secured by snap tabs similar to the tabs 25 of FIG. 3 embodiment. The notebook computer 300 is similar to the notebook computer 100 of FIG. 4 in that the water-sealing mechanism 120 is also applied to around an inside edge of the bay 311 although it is not visible in FIG. 6. The system unit 302 has four corners at rear ends 321 and front ends 322. The drain channels 320 extend at least portions of the opposite side edges of the system unit 302 to communicate the interior of the bay 311 to atmosphere of the computer 300 at openings located at the front ends 322. With the system unit 302 tilted up a little at the rear ends 321 relative to the front ends 322 containing the drain holes, any possible liquid spillage through the key module 312 will gravitate towards the drain channels 320; causing the liquid to flow out of the key bay 311.

To tilt the rear ends 321 up, traditional pullout tabs 323 may be installed at the bottom of the system unit 302. Alternatively, the base module 311 containing the system unit 302 of the computer 300 may be manufactured to be thinner on the front ends 322 of the drain channels 320 and thicker on the other ends 321, to create the required tilt for liquid to flow downwards.

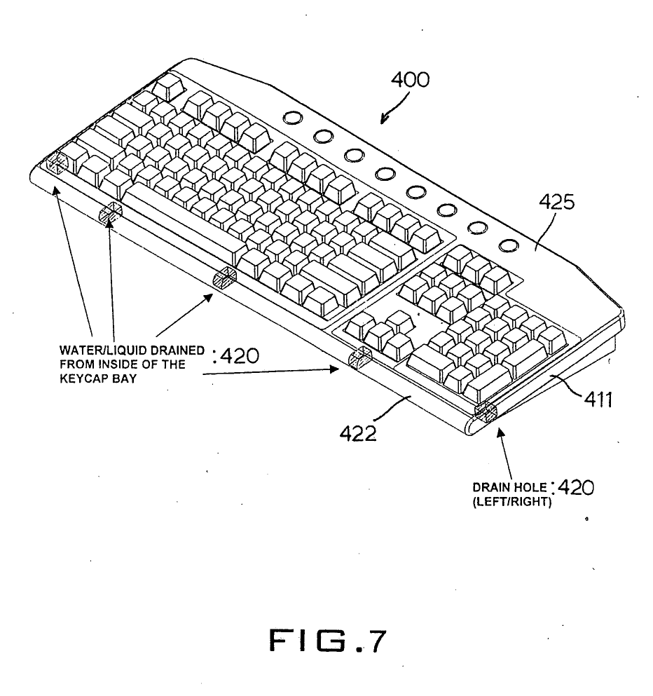

In FIG. 7, a keyboard 400 according to another embodiment of the present invention has a rectangular base module 411, which defines a rectangular bay over its entire upper surface. Water channeling mechanism 420 in the form of drain holes is formed about a lower end 422 of the keyboard 400 facing the front and sides thereof. The keyboard 400 has a water-sealing mechanism (not shown) similar to the mechanism 23 of FIG. 3 embodiment except that it now has four sides different from the eight sides because a key module 425 is shaped after the base module 411 to mate at four sides.

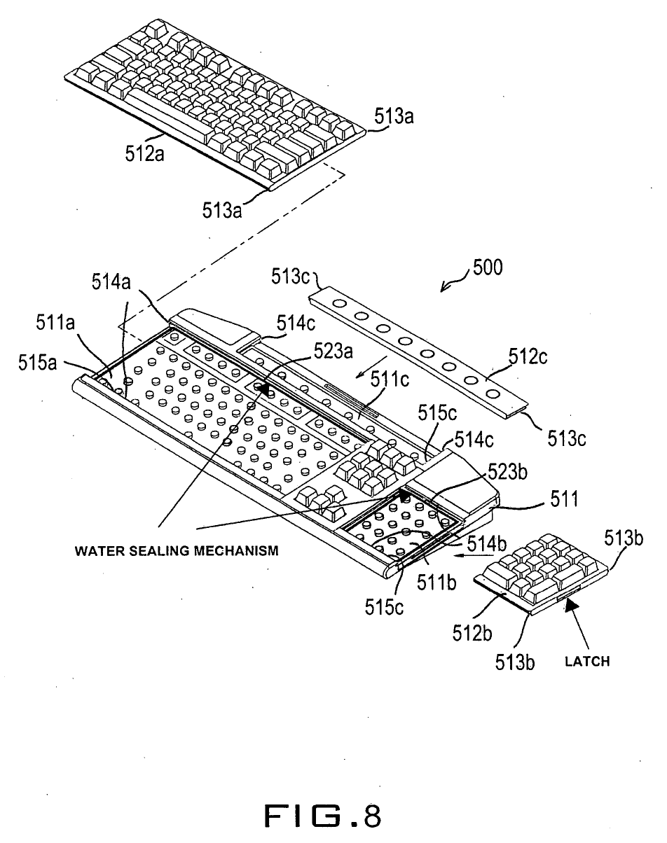

FIG. 8 shows a keyboard 500 having a single base module 511 that is subdivided into multiple bays. The sub-bays include a primary bay 511a for seating an alphanumeric key module 512a, a side bay 511b for seating a numeric key module 512b, and a rear bay 511c for releasably holding a customizable key module 512c, etc. The key modules 512a, 512b and 512c has two opposite side edges 513a-513a, 513b-513b and 513c-513c for sliding engagement with opposing guide rails 514a, 514b and 514c formed in inward rims 515a, 515b and 515c of the sub-bays 511a, 511b and 511c, respectively. Then, they can be secured to each other by employing a latch-hinge mechanism.

For each sub-bays, a rectangular water sealing mechanism is installed although only two of them are shown at 523a for the primary bay 511a and at 523b for the side bay 511b.

FIG. 9 is a schematic drawing in an exploded cross sectional view of the first embodiment of the present invention of FIG. 3 wherein top drawing shows the key module 12 separated from the bay 11 according to the present invention. This is the desktop computer keyboard construct.

FIG. 9 bottom drawing shows the key bay 11 having beneath it two layers of water sealing mechanism used in a traditional type keyboard construct: one above the holding plate, one (extra layer) below the holding plate. The water-sealing mechanism 23 may be formed by this three-layer plate bearing against a shoulder 24a formed around the inside rim 24 of the upper enclosure 18 of the base module 11. Or it may be a gasket secured firmly between the shoulder 24a and the key-actuating rubber dome 16.

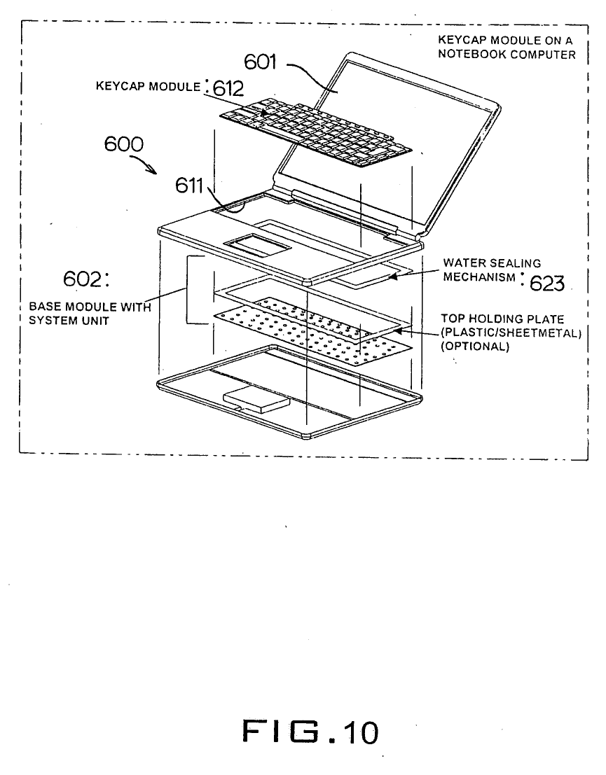

FIG. 10 is an exploded view of a notebook/laptop computer 600 having a monitor 601 hinged to a system unit 602, which comprises a bay opening 611 on the top surface with a key module 612 removed from the opening 611 to show the relative vertical position of a water sealing mechanism 623.

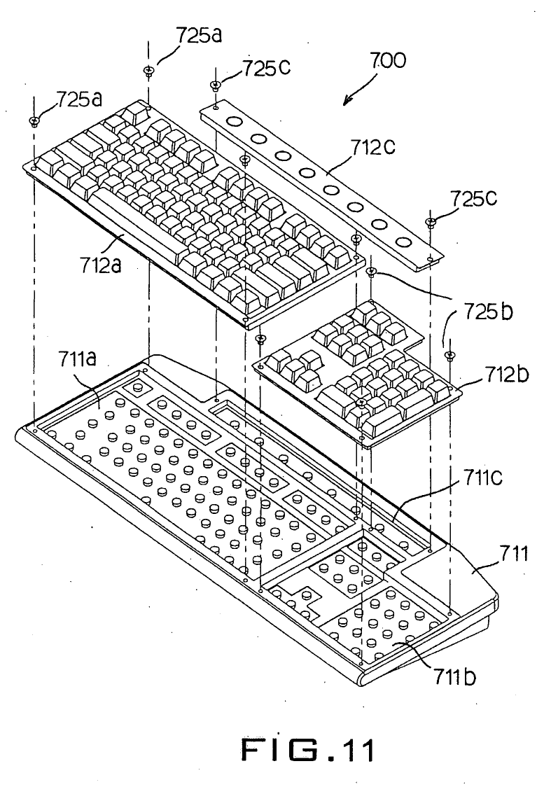

FIGS. 11 to 14 show the various methods of mounting the key module to the bay/base module.

As in FIG. 11, the mounting may be achieved by using screws in the top-down orientation of a keyboard 700 having multiple sub-bays on a single base module 711. Firstly, an alphanumeric key module 712a may be placed in a primary bay 711a by four corner screws 725a to allow a future unscrewing by the user for maintenance. Secondly, a numeric key module 512b may be fastened to a side bay 711b by four screws 725b until they are unscrewed for a localized maintenance in the area. To releasably hold a customizable key module 712c down to a rear bay 711c, two screws 725c may be sufficient.

Alternatively, bottom-up screws can mount the key modules 712a-712c.

FIG. 12 shows a keyboard 800 having a key module 812 that can be mounted and secured to a base module 811 by yet another form of snap-in mechanism comprising four tab-like hooks 825 on the key module, so that the user can remove the top key module by slightly prying away the hooks and unseat the key module away from the base module. The hooks 825 are adapted to clinch the base module 811 at four corresponding vertical slots 826 formed at its comers. In this drawing, an upper enclosure of the traditional desktop computer keyboard is modified into a part of the key module 812.

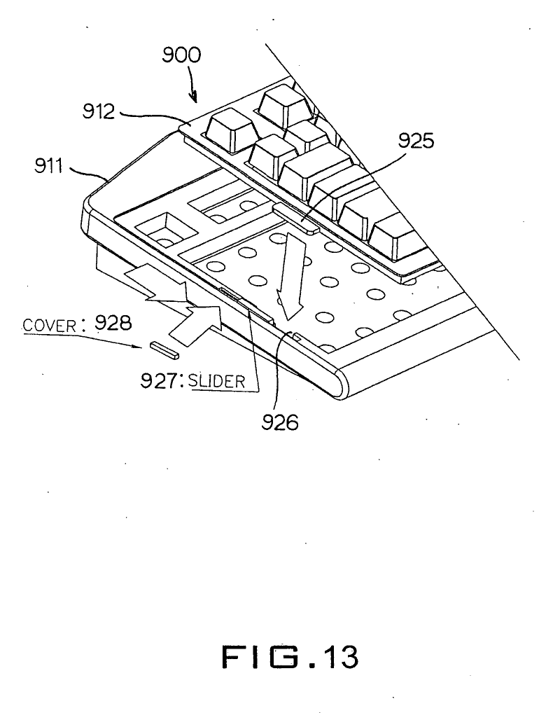

FIG. 13 shows a keyboard 900 having a key module 912 that can be mounted and secured to a base module 911 by employing tabs 925 extending from the sides of the key module 912, and corresponding cavities 926 on the sides of the base module 911 with sliding locking pins 927 to engage or disengage the tabs 925. The voids where the pins 912 left may be covered by pieces 928. The allocation of tabs/cavities can be reversed, that is, the tabs 925 can be on the sides of the base module 911, while the sliding locking pins are on the sides of the key module 912.

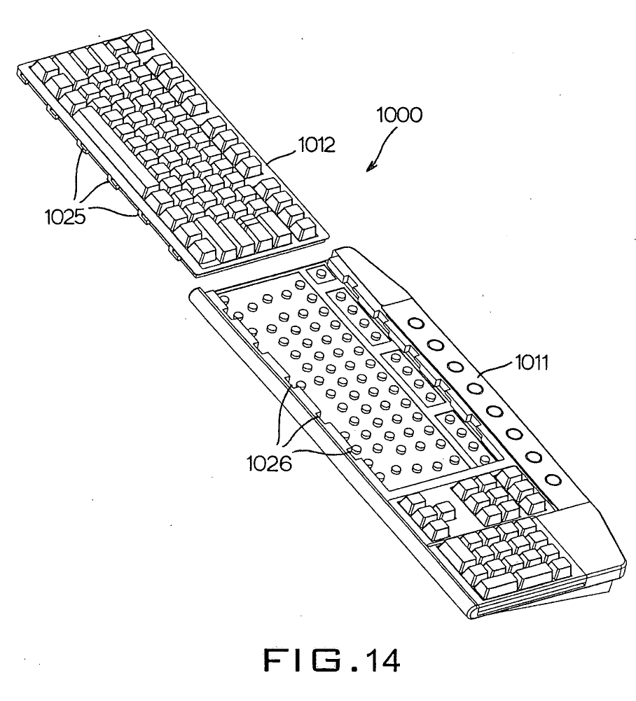

FIG. 14 shows a keyboard 1000 having a key module 1012 that can be mounted and secured to a base module 1011 by horizontally sliding the key module 1012 into the base module 1011. A number of tabs 1025 and hooks 1026 are used to engage and disengaged the key module 1012.

FIG. 15 shows an example of implementation by the present invention where portions of a base module are assembled into a key seating bay 11a by bottom-up screws. The water-channeling mechanism (drain holes) 20a is positioned at the lowermost level in use relative to other areas of the bay 11a to allow liquids to flow out. Here, a key module 12a is provided with a key actuating mechanism 16a comprising a rubber sheet/dome with a spring attached to it on a keycap holding plate 14a.

FIG. 16 shows another example of implementation by the present invention where an all-around rubber seal 23a having a T-shape in cross section is used as a water-sealing mechanism for a base module 11b. This rubber seal 23a will be laid around the inside rim of the bay 11b. The rubber seal 23a is provided with openings (not shown) at corresponding positions to the drain holes 20b of the water channeling mechanism around a lower portion of the key bay 11b. A key module 12b has arrays of key 15b and is integrated with a key actuating mechanism 16b comprising a rubber sheet/dome with a spring attached to it on a keycap holding plate 14b.

Therefore, while the presently preferred form of the keyboard has been shown and described, and modifications thereof discussed, persons skilled in this art will readily appreciate that various additional changes and modifications may be made without departing from the spirit of the invention, as defined and differentiated by the following claims.

What is claimed is:

1. A two module keyboard with splash-resistant mechanism for desktop or notebook/laptop computers comprising:
a. a key module generally shaped into a board having at least four sides and including a plurality of keycaps, a key holding mechanism and a frame, said key-module containing no electronic circuitry and being self-sustainable in and out of said keyboard;
b. a base module containing the electronic circuitry used for decoding the signals of said keycaps depressed by a computer user to provide the decoded signal to said computer through a wired or wireless connection, said base module defining a bay area over most of its upper surface shaped to fit said key module when it docks into the bay in manufacturing process and subsequent events of maintenance performed by the user;
c. said bay of said base module being tilted from the horizontal plain to an adjustable degree and having an inner rim abutting said key module at its entire sides leaving a plurality of holes for communicating the inner space of said rim to lowermost points of said tilted bay;
d. a water-sealing mechanism disposed around the inside lower rim of said bay, so that any liquid spillage or splash into the space between said key module and base module will not get inside the body of the keyboard or notebook/laptop computer but gravitates towards said holes and out of the computer; and
e. a means for releasably mounting said key module onto said base module or the bay, whereby the user may seat and unseat said key module in and out of said base module casually for cleaning behind said key module to remove liquid or foreign matter normally untouchable by the user.

2. The keyboard of claim 1, wherein said key module can be subdivided into two, three or more sub-keycap-modules.

3. The keyboard of claim 1, 2 or 3, wherein said means for mounting said key module to said base module or bay is one or a plurality of screws in the top-down orientation, so that the user can remove said key module by removing the screws and unseat the key module away from said base module or bay.

4. The keyboard of claim 1, 2 or 3, wherein said means for mounting said key module to said base module or bay is provided by one or a plurality of snap-in tabs formed on one of said key and base modules and opposing cavities formed on the other of said key and base modules, so that the user can remove said key module by depressing said snap-in tabs from its engaged cavity and unseat the key module away from the base module or bay.

5. The keyboard of claim 1, 2 or 3, wherein said means for mounting said key module to said bay is provided by one or a plurality of latch-hinge mechanisms, so that the user can remove said key module by unlatching and unhinging said key module and unseat said key module away from said base module or bay.

6. The keyboard of claim 1, 2 or 3, wherein said means for mounting said key module to said bay is provided by one or a plurality of slidable locking pins on said bay with corresponding holes on said key module, so that the user can remove the key module by sliding the pins to slidingly disengage said pins and unseat the key module away from said base module or bay.

7. The keyboard of claim 1, 2 or 3, wherein said means for mounting said key module on top of said base module is provided by one or a plurality of tab-like hooks on said key module, so that a user can remove the top key module by slightly prying away the hooks and unseat the key module away from said base module or bay.

8. The keyboard of claim 1, 2 or 3, wherein said water-sealing mechanism is a strip of rubber tightly laid around the inside lower rim of said bay, but not blocking the plurality of holes.

9. The keyboard of claim 1, 2 or 3, wherein said key module contains a key actuating mechanism.

10. A splash-resistant modular keyboard for desktop and notebook/laptop computers, comprising:
a. a key module removably sitting in a bay sized to fit the shape of said key module on the top surface of a desktop keyboard or notebook/laptop computer;
b. a material forming the bay with a means to lower one end of the bay and containing a plurality of holes so that liquids will gravitate towards the holes and out of the bay;
c. a water-sealing mechanism around the inside lower rim of the material forming the bay, so that any liquid spillage or splash will not get inside the body of the keyboard or notebook/laptop computer; and
d. a means for mounting so that said key module can be easily mounted to and removed from the material forming the bay.

11. The keyboard of claim 10, wherein said key module is made up of individual keys, key holding mechanism, frame and optional key actuating mechanism.

12. The keyboard of claim 11, wherein said key-module can be subdivided into two, three or more sub-key-modules.

13. The keyboard of claim 11 or 12, wherein the said means for mounting said key-cap module to the material forming the bay is by one or a plurality of screws in the top-down orientation, so that a user can remove said key-module by removing the screws and unseat the key-module away from the material forming the bay.

14. The keyboard of claim 11 or 12, wherein the said means for mounting said key-module to the material forming the bay is by one or a plurality of snap-in tabs, so that a user can remove said key-module by depressing said snap-in tabs from its engaged cavity and unseat the key-module away from the material forming the bay.

15. The keyboard of claim 11 or 12, wherein the said means for mounting said key-module to the material forming the bay is by one or a plurality of latch-hinge mechanisms, so that a user can remove said key-module by unlatching and unhinging said key-module and unseat said key-module away from the material forming the bay.

16. The keyboard of claim 11 or 12, wherein the said means for mounting said key-module to the material forming the bay is by one or a plurality of slidable locking pins on the material forming the bay with corresponding holes on said key-module, so that a user can remove the key-module by sliding the pins to disengage the slide-lock and unseat the key-module away from the material forming the bay.

17. The keyboard of claim 11 or 12, wherein the said means for mounting said top key-module to said bottom base-module is by one or a plurality of tab-like hooks on said key-module, so that a user can remove the top key-module by slightly prying away the hooks and unseat the top key-module away from the bottom base-module.

18. The keyboard of claim 10, wherein said water sealing mechanism is a strip of rubber tightly laid around the inside lower rim of the material forming the bay, but not blocking the plurality of holes.
